(19) United States
(12) Patent Application Publication
(10) Pub. No.: US 2002/0027921 A1
(43) Pub. Date: Mar. 7, 2002

(54) Apparatus and methods for providing hosted services over an asynchronous transfer mode connection

(76) Inventor: Edward A. Brinskele, Nicasio, CA (US)

Correspondence Address: Finnegan, Henderson, Farabow, Garrett & Dunner, L.L.P., 1300 I Street, N.W., Washington, DC, 20005-3315, US

(21) Appl. No.: 09/928,435

(22) Filed: Aug. 14, 2001

Related U.S. Application Data
(60) Provisional application No. 60/225,626, filed on Aug. 15, 2000.

(51) Int. Cl. H04L 12/28; H04L 12/52

(52) U.S. Cl. 370/395.51; 370/395.52

(57) ABSTRACT

This disclosure describes apparatus and methods for hosted services over an asynchronous transfer mode (ATM) connection, such as an ATM network. The hosted services include hosted communication services and hosted application services. A hosted communication service connects a customer, such as a business, to a hosting server that provides communication services to the customer, such as telephone services as well as e-mail, voice mail, and fax capabilities. A hosted application service connects a customer, such as a business, to a hosting server that provides application software to the customer, such as enterprise software as well as any other type of application software. An ATM connection is used to connect the customer to the hosting server.

### I. RELATED APPLICATIONS

This application claims the benefit of U.S. Provisional Patent Application No. 60/225,626 with a filing date of Aug. 15, 2000, which is incorporated herein by reference.

### II. BACKGROUND OF THE INVENTION

A. Field of the Invention

The present invention relates to apparatus and methods for providing hosted services over a high-speed connection to a customer. More particularly, the invention relates to apparatus and methods for providing hosted communication services and hosted application services over an asynchronous transfer mode (ATM) connection to a customer.

B. Description of the Related Art

Hosted Communication Services

Prior to hosted communication services, businesses had to rent, lease, or purchase telephone facilities to support multiple users of telephone services. Such telephone facilities include primary exchange switching hardware and/or other key telephone system equipment. However, hosted communication services enable businesses to spare the expense of purchasing and maintaining telephone facilities. In addition, hosted communication services have the advantage that businesses no longer have to keep up with costly technology, such as updating the infrastructure for the telephone facilities.

Businesses have recognized the convenience of hosted communication services for decades. Since the 1960's, for example, businesses have had the opportunity to subscribe to a central office exchange service from local telephone companies, such as, for example, the Centrex service offered by the various telephone companies. The Centrex service provides a business with multiple telephone lines, allowing the business to avoid purchasing or managing its own telephone facilities. The Centrex service effectively partitions the capabilities of the telephone company's facilities among its business customers. Each business customer may utilize the allocated partition of the telephone company's telephone facilities for a monthly fee, and these partitions are maintained by the central office equipment at the telephone company. In other words, the Centrex service is a hosted private branch exchange (PBX) service.

The Centrex service may be implemented on various switching platforms, such as the 1AE-Western Electric class 4/5 central office switch, the Lucent 5E class 4/5 digital switching system, the Northern Telecom DMS series of digital central office switches, and the GTE/GTD1000 series of class 4/5 central office switches. These switching platforms may use analog or digital line interfaces. The digital line interfaces may employ pulse code modulation (PCM) encoding technology in a time division multiplexing (TDM) scheme.

However, although the Centrex service provides a hosted PBX service, the Centrex service is becoming increasingly archaic in today's electronic society. For example, to provide the Centrex service, telephone companies must manually install pairs of copper wire at the customer's premise. Telephone companies also must change the configuration of the central office equipment to separate users within a business. These configurations include both hardware and software modifications to partition common equipment and termination plug-in cards. This can become very cumbersome. Indeed, each time a business requests even a minor change in service (e.g., adding or relocating a user, adding or removing a service feature, etc.), installation personnel from the telephone company must manually modify the central office equipment and the wiring at the customer's premise. On average, this type of service change could take up to 5 days to complete. That is 5 days the business must wait without the change in service. This is a significant disadvantage.

Hosted Application Services

Separate from hosted communication services (or hosted PBX services), there are companies that provide hosted application services, such as, for example, enterprise software. Enterprise software allows businesses to integrate applications and data so that they may be used across an entire business. Prior to hosted applications, a business wanting enterprise software, such as, for example, PeopleSoft, would have to purchase the application software and hire a hosted application service provider, such as, for example, Exodus, to set up and monitor a server, which would house the application software. During the set-up phase, the hosted application service provider would install the software onto a local area network (LAN) and update all of the workstations so that the entire business has access to the server. During a monitoring phase, the hosted application service provider then maintains the hosted application services.

A hosted application service provider has an incredible overhead of technology to maintain hosted application services. For example, Exodus hosts a number of NT servers, UNIX servers, and Cisco routers. These systems provide a complete disaster recovery environment, which may cost millions to create. Further, Exodus provides facilities with raised floors, HVAC (heating, ventilating, and air-conditioning) temperature control systems, and seismically braced racks. The facilities also include smoke detection and fire suppression systems, motion sensors, and secured access, as well as surveillance and security breach alarms. In addition, within these facilities, there are a number of redundant subsystems, such as multiple fiber trunks entering each Internet data center, redundant power to the premises, and multiple backup generators, including uninterruptible power systems (UPS), and redundant servers. All of these systems and subsystems reduce downtime that may occur due to power glitches, a server going down, or a host of other problems. And, all of these systems and subsystems are expensive to establish and maintain. This is a substantial disadvantage.

Connection Alternatives

Whether a business utilizes hosted communication services or hosted application services, the business must have means to form a connection between the business and the hosted service. For example, the Centrex service (a hosted communication service) utilizes hard-wired connections between the business and the telephone company, and Exodus (a hosted application service provider) utilizes Internet protocol (IP) type connections over T1 lines. However, none of the current hosted services offer hosted services over an asynchronous transfer mode (ATM) network.

Like IP, ATM is a packet network. Unlike IP, ATM has control of routing. This difference makes ATM more reliable and predictable than IP. In an IP network, data may be routed in an indirect manner. For example, to reach a web site across the street, an IP router may route data thousands of miles in an opposite direction before sending it to its destination. This inefficient routing causes problems such as latency delay. For communications that do not require real-time service, such as e-mail, latency delay may not be a problem. However, for communications requiring real-time service, such as telecommunications, latency delay is debilitating. For example, in a telephone conversation with latency delay, users may begin talking before hearing an earlier response. Similar problems occur with video conferencing.

IP proponents advocate IP (at least, IP version 4 (IPV4)) over ATM because of economic reasons. The IP proponents believe that IP is more affordable, and thus more desirable than ATM, because ATM currently costs 7-15% more than IP. However, as ATM technology improves, this price differential will disappear. Once the price differential disappears, customers will focus more on reliability issues, and ATM will become more widely used (perhaps even a standard). Even with the expected introduction of IP version 6 (IPV6), which will include the prioritization necessary to handle real time and time critical data, ATM will still retain the advantages of reliability and predictability.

Businesses are already recognizing the advantages of ATM. Today, major telecommunications companies, such as MCI Worldcom, are installing ATM networks. One of the reasons for the growth in ATM networks is the ability of ATM to integrate various networks. For example, today there are cellular networks, voice networks, and frame networks. Each of these different networks cannot communicate with each other. However, with an ATM core network installed to connect these networks, inter-network communication is possible.

Hosted Services over ATM

What is desired in the art today is hosted communication services over an ATM connection. As described above, the Centrex service offers a hosted PBX. However, the Centrex service does not provide ATM connections, which allow integration of the various types of networks. Further, changes to the PBX using the Centrex service, such as adding a user or opening another business location, require manual changes to the PBX and to the customer premises, which may take days to complete. What is needed is a hosted communication service (such as, for example, a hosted PBX) over an ATM connection that allows for inter-network communications and allows changes in service to be made to the system electronically, such as by placing a request over the Internet.

What is also desired in the art today is hosted application services over an ATM connection. As described above, there are hosted application service providers (e.g., Exodus) that offer hosted application services. However, these hosted application service providers do not provide application services over ATM connections. If a hosted application service used ATM connections, the efficiency and reliability of the applications would be enhanced, such as, for example, the availability of unified messaging (including voice mail, e-mail, and facsimiles). These types of hosted application services could also include enterprise software.

What is also desired in the art today is the combination of hosted communication services and hosted application services over an ATM connection. This combination of services using ATM connections would provide the benefits of both hosted services in a single, unified hosted service. This unified hosted service would allow for the delivery of seamless hosted services to any number of businesses at any number of geographic locations.

### III. SUMMARY OF THE INVENTION

Apparatus and methods consistent with the present invention overcome the shortcomings of the conventional systems by providing hosted services over an asynchronous transfer mode connection, including hosted communication services and hosted application services. Additional objects and advantages of the invention will be set forth in part in the description, which follows, and in part will be obvious from the description, or may be learned by practice of the invention. The objects of the invention will be realized and attained by means of the elements and combinations particularly pointed out in the appended claims.

A method consistent with the present invention provides a hosted service to a customer. The service may be hosted on a hosting server. The service may be provided to the customer via an asynchronous transfer mode connection to the hosting server.

Additional aspects of the invention are disclosed and defined by the appended claims. It is to be understood that both the foregoing general description and the following detailed description are exemplary and explanatory and are intended to provide further explanation of the invention as claimed.

### IV. BRIEF DESCRIPTION OF THE DRAWINGS

The accompanying drawings are included to provide a further understanding of the invention, are incorporated in and constitute a part of this specification, illustrate preferred embodiments of the invention, and, together with the description, serve to explain the principles of the invention.

In the drawings,

FIG. 1 is a general block diagram illustrating a system consistent with an embodiment of the present invention;

FIG. 2 illustrates some of the types of information of the business handled by the system consistent with the embodiment of the present invention, as shown in FIG. 1;

FIG. 3 illustrates some of the exemplary operating systems for the hosting server handled by the system consistent with the embodiment of the present invention, as shown in FIG. 1;

FIG. 4 illustrates a block diagram illustrating a system consistent with another embodiment of the present invention;

FIGS. 5A and 5B illustrate two embodiments of the prior art Centrex service;

FIG. 6 illustrates an ATM switch system of a customer or business consistent with an embodiment of the present invention;

FIG. 7 illustrates multiple ATM switch systems of a customer or business having multiple locations consistent with another embodiment of the present invention;

FIG. 8 illustrates an ATM switch system consistent with yet another embodiment of the present invention; and

FIG. 9 illustrates a block diagram illustrating a hosting server consistent with an embodiment of the present invention.

### V. DETAILED DESCRIPTION

A. Introduction

Apparatus and methods consistent with the principles of the present invention as disclosed herein provide for hosted services over an asynchronous transfer mode connection, including hosted communication services and hosted application services. These apparatus and methods avoid the shortcomings of the conventional apparatus and methods by allowing service changes without requiring expensive and inefficient hardware and/or software changes and by allowing the interconnectivity of different types of networks.

B. General Description

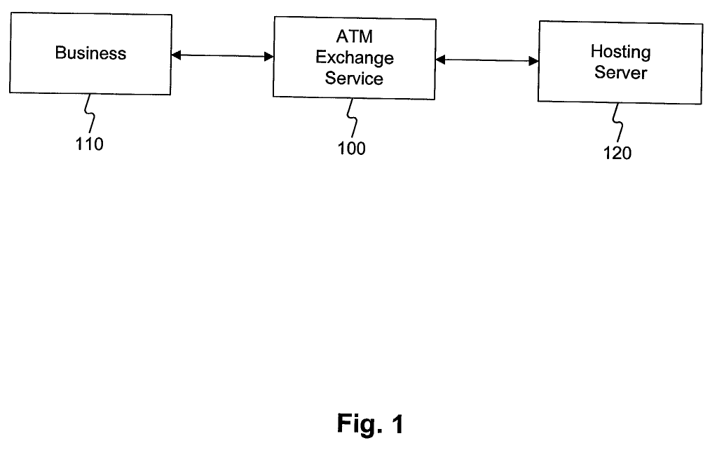

FIG. 1 is a general block diagram illustrating a system consistent with an embodiment of the present invention. FIG. 1 depicts an ATM exchange service 100 interfacing a business 110 and hosting server 120. The business 110 may be any business subscribing to the hosting server 120. The business 110 may be located at a plurality of locations. The hosting server 120 includes functionality for running the communication services and/or application services of the business subscribing to the hosting server 120. The ATM exchange service 100 is a system that provides an ATM connection between the business 110 and the hosting server 120.

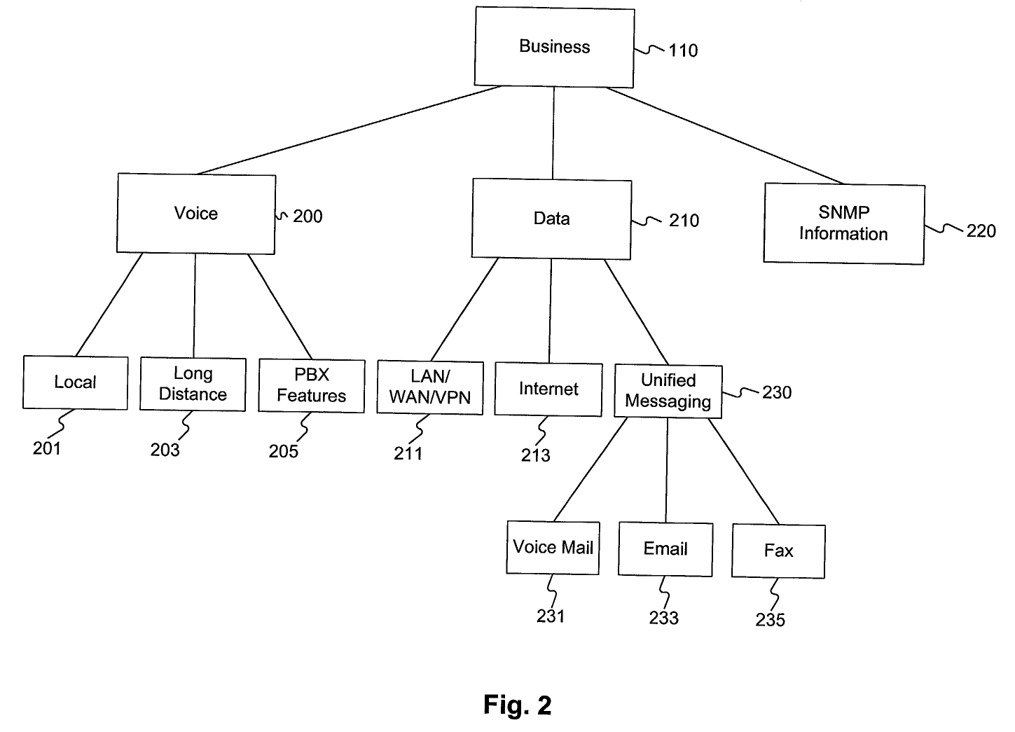

FIG. 2 illustrates some of the types of information of the business handled by the system consistent with the present invention, as shown in FIG. 1. As shown in FIG. 2, a business 110 may have voice 200, data 210, or Simple Network Management Protocol (SNMP) information 220. Voice information 200 includes local telephone 201, long distance telephone 203, and PBX features 205, such as, for example, call waiting, call forwarding, conference calling, and similar special features. Data 210 includes a local area network (LAN), a wide area network (WAN), and/or a virtual private network (VPN), i.e., LAN/WAN/VPN 211. A LAN and a WAN are now standard network architectures. A VPN is another network architecture, which allows each office of a business to appear to be in the same location by providing dedicated data access. Data 210 also includes Internet 213. Data 210 still further includes unified messaging 230. Unified messaging 230 includes voice mail 221, email 233, and fax 235. SNMP information 220 provides network management information, such as the status of print jobs. Business 110 may also include other information (not shown).

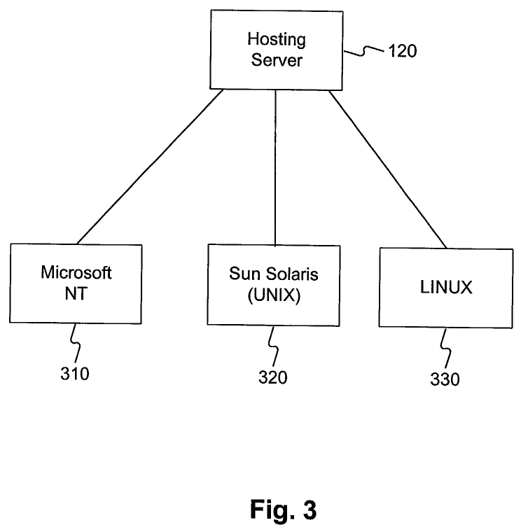

FIG. 3 illustrates some of the exemplary operating systems for the hosting server handled by the system consistent with the embodiment of the present invention, as shown in FIG. 1. Some of the operating systems for hosting server 120 may include Microsoft NT 310, UNIX 320 or LINUX 330. However, the present invention is not limited to a particular operating system.

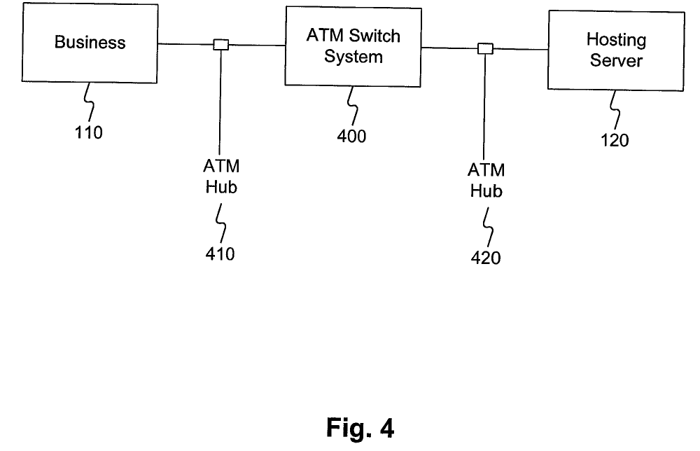

FIG. 4 illustrates a block diagram illustrating a system consistent with another embodiment of the present invention. As shown in FIG. 4, an ATM hub 410 couples an ATM switch system 400 to a business 110, and another ATM hub 420 couples the ATM switch 400 to a hosting server 120. ATM hubs 410 and 420 are termination hubs familiar to those in the art. ATM hub 410 may be placed on a customer's premises for converting the data to an appropriate format (e.g., appropriate connection, appropriate protocol, appropriate ports, etc.), or ATM hub 410 may be located elsewhere. ATM hub 410 may convert a call at the sending premise from PBX (i.e., the analog phone format) to ATM (i.e., an Ethernet format according to the invention). ATM hub 410 then may route the data to the ATM switch system 400. ATM switch system 400 routes information through the network using ATM switching.

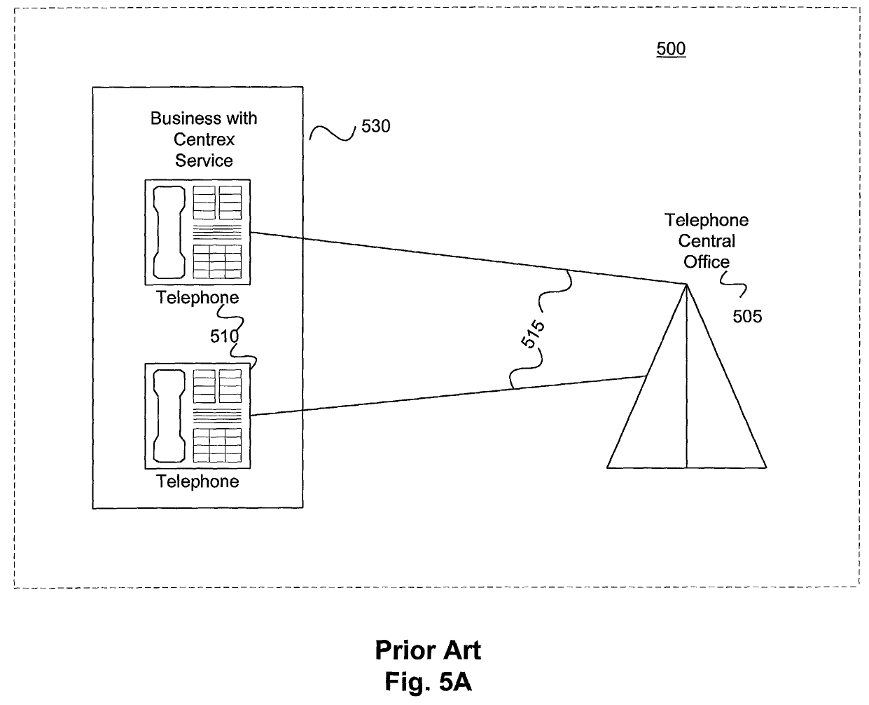

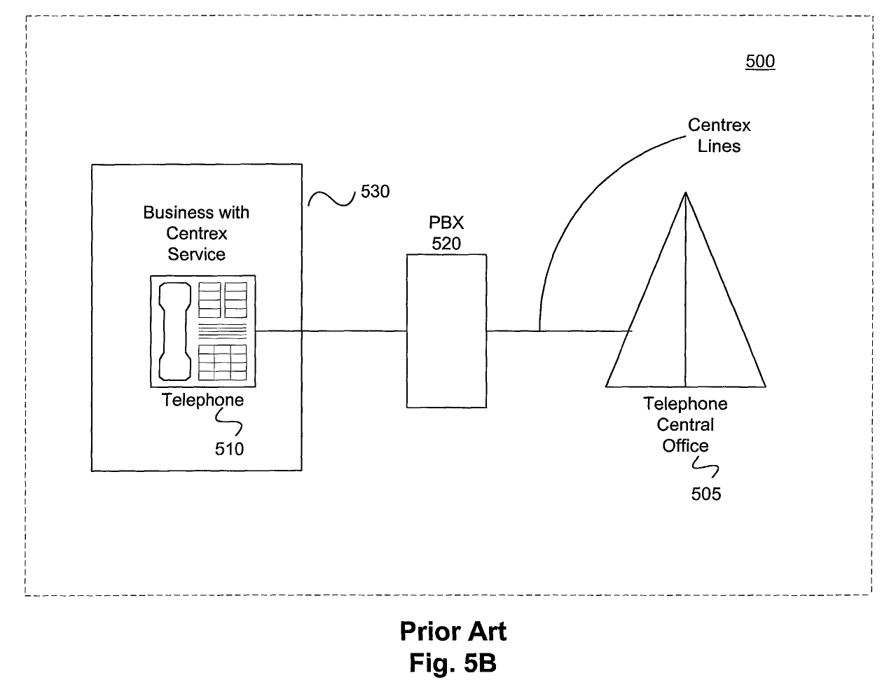

FIGS. 5A and 5B illustrate two embodiments of the prior art Centrex service. As described above, the Centrex service essentially provides a hosted PBX service and various voice services, such as call-forwarding, etc., for a business. Before Centrex, a business typically would purchase and manage a PBX, because it is less expensive than connecting an external telephone line to every telephone line in the business. A PBX allows telephone users within a business to share a certain number of outside lines external to the PBX. Within the PBX, a telephone user may call another user by dialing a four digit number, for example. However, owning, renting, leasing, or managing a PBX is costly. The prior art Centrex service saves a business the expense of a PBX by partitioning a portion of a local telephone company's hardware and software for a business and providing a PBX for the business. Thus, the local telephone company typically owns the communications equipment necessary to implement a PBX for the business and performs the switching at its premises.

FIG. 5A shows a telephone company, such as a telephone central office 505 directly connected to phones 510 at a business with Centrex service 530. As shown in FIG. 5A, Centrex system 500 has multiple telephone lines 515 from the business with Centrex service 530 connected directly to telephone central office 505. Telephone central office 505 partitions the group of telephone lines 515 shown as well as hardware and software (not shown) to implement a PBX for the business with Centrex service 530.

Telephone central office 505 generally processes the calls in FIG. 5A with switching. Switches allow an electronic signal to perform the connection necessary to process the telephone call without any physical operation of a closed relay, for example. Alternatively, the telephone central office 505 may process the calls using closed relays. Closed relays are an older technology which requires a physical closure of a relay to process a telephone call.

FIG. 5B is a block diagram illustrating another prior art Centrex system. As shown in FIG. 5B, telephone central office 505 is connected to phones 510 at a business with Centrex service 530 through a PBX 520. Centrex system 500 in FIG. 5B has a single telephone connection from the business with Centrex service 530 to PBX 520, which is then connected to telephone central office 505. Typically, PBX 520 is owned and operated by telephone central office 505. However, in an alternative embodiment, PBX 520 may be an existing PBX at the customer's premise. Whoever owns and operates PBX 502, it generally processes telephone calls with switches. However, in an alternative embodiment, closed relays may be used. Similarly, telephone central office 505 generally processes telephone calls with switches, but telephone central office 505 may also use closed relays. Centrex system 500 additionally provides voice services, such as call-forwarding, etc., to the business with Centrex service 530 (not shown).

Thus, in the prior art systems in FIGS. 5A-5B, Centrex system 500 partitions a portion of itself for a business to share a group of outside lines. The switching performed by Centrex system 500 requires a particular configuration of hardware, such as switches and wires, in a large switching center. Thus, to make changes to the telephone service, Centrex system 500 must reconfigure the equipment at the telephone central office 505 (i.e., hardware and software) and possibly the wires at the customer's premise (i.e., at business with Centrex service 530).

In contrast, ATM switching is software-based and does not require the specific hardware of a switching center for implementation. Instead, ATM switching includes packet software that accepts incoming packets and sends them to their destination addresses. ATM switching cannot only be used for carriers in switching centers, but ATM switching may also be used on any server for customers in a PBX environment. The present invention provides for an ATM switch to be used to connect a customer to another location, such as, for example, connecting a customer or business to a hosting server.

Current ATM systems have an 8 to 1 efficiency compared with pulse-code modulation (PCM) technology for transmitting voice. It is estimated that within one year this computation will be 22 to 1 efficiency. About 3 years from now, the estimated efficiency is predicted to be 48 to 1. These efficiency calculations show that the capacity of ATM switching will actually increase to the customer or business, without additional bandwidth being added (such as adding another T1 line). The only thing that will change is the operation of the ATM at the ATM hubs, such as ATM hubs 410 and 420, as shown on FIG. 4. Specifically, the only thing that will change is the software encoding algorithm of the ATM at the ATM hubs. This is a great advantage for the customer or business, which uses ATM switching.

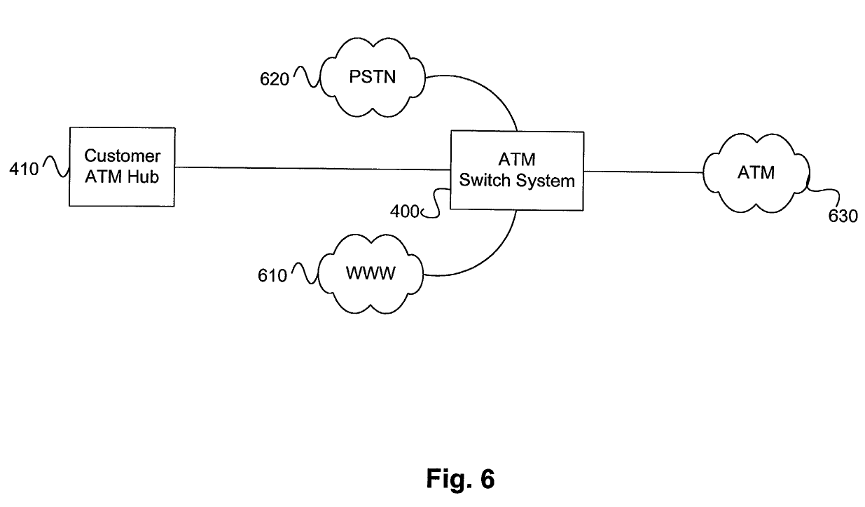

FIG. 6 illustrates an ATM switch system of a customer or business consistent with an embodiment of the present invention. As shown in FIG. 6, an ATM switch system 400 may route customer data from a customer ATM hub 410 to the world wide web (WWW) 610, the public switch telephone network (PSTN) 620, or the global ATM network 630, including any combination thereof. The WWW 610 allows the customer at customer ATM hub 410 to connect to the Internet in the traditional manner. The PSTN 620 also allows the customer at customer ATM hub 410 to connect to a telephone network in the traditional manner. The global ATM network 630 allows the routing of customer data from customer ATM hub 410, such as voice traffic, from one person to another person within the same business, even though the other person may be located in a geographically remote location. Also, when the customer data (e.g., voice traffic) is directed to a remote location, the connection may be made using a local number.

Notably, as shown in FIG. 6, the customer ATM hub 410 connects directly to an ATM switch system 400. Thus, the present invention removes the need for the telephone company in making calls within a business, even if the business contains multiple locations. It will be apparent to those skilled in the art that the present invention may be expanded to remove the need for the telephone company in making calls outside of the business as well. That is, in an embodiment of the present invention, the PSTN may be eliminated.

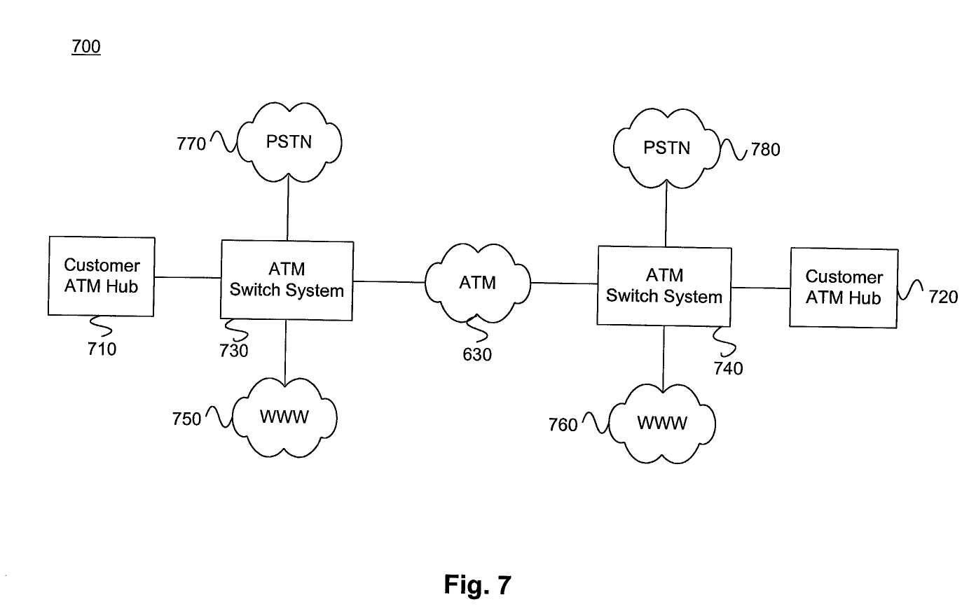

FIG. 7 illustrates the multiple ATM switch systems of a customer or business having multiple locations consistent with another embodiment of the present invention. As shown in FIG. 7, two customer ATM hubs 710 and 720 at separate geographic locations within a business may be connected via a global ATM system 630, which is a global ATM network, through each respective ATM switch system 730 and 740. The ATM switch systems 730 and 740 may also connect the customer or business to the respective WWW 750 and 760 and/or to the respective PSTN 770 and 780. Also, note that ATM network 700 may be a virtual private network (VPN). The VPN allows each office of a business to appear to be in the same location. In a VPN, it looks like the offices are connected, but there are no physical lines running between the offices. Additionally, as noted earlier, a VPN provides dedicated data access. This access may be obtained through a variety of ways, including, for example, a dial-up connection, a digital subscriber line (DSL) connection, or a frame relay connection.

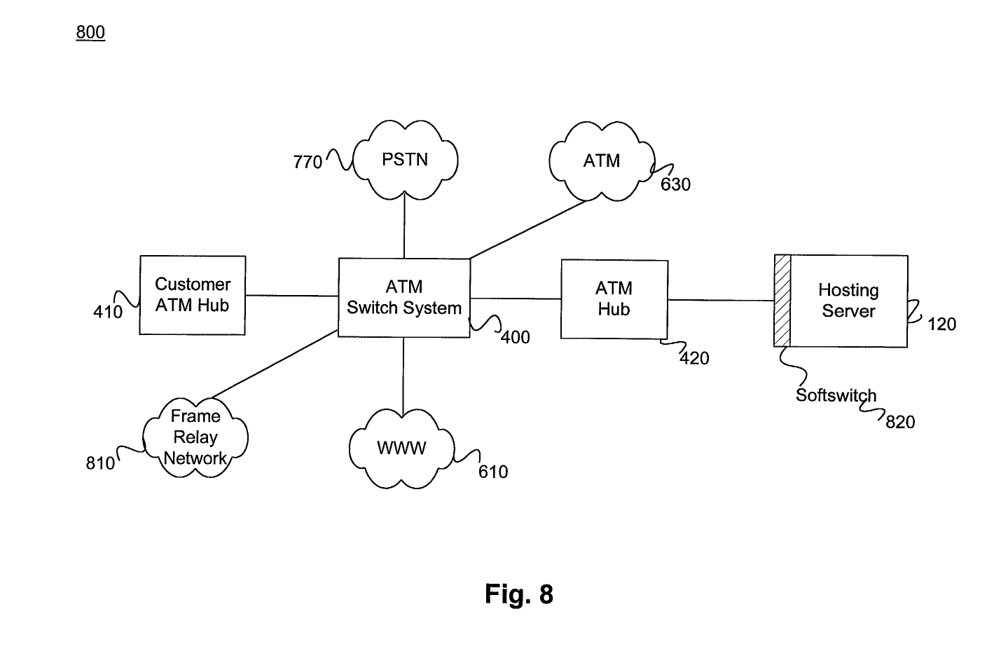

FIG. 8 illustrates an ATM switch system consistent with yet another embodiment of the present invention. As shown in FIG. 8, ATM network 800 includes ATM switch system 400, which is connected to a customer ATM hub 410, a hosting server 120 via another ATM hub 420, the WWW 610, the PSTN 770, a global ATM network 630, and a frame relay network 810. The frame relay network 810 is a data network using a simplified form of packet switching in which synchronous frames of data are routed to different destinations depending on header information.

As shown in FIG. 8, ATM network 800 has the capability for interfacing the hosting server 120 to the ATM switch system 400 via the ATM hub 420, such as, for example, by use of a Softswitch 820. Softswitch 820 is software for a server, such as an NT server at hosting server 120, that allows an ATM connection to be made with the server. Because ATM enables a real-time connection, the Softswitch 820 may be used on an NT server to host a PBX environment for a phone user without delay or lag time. In a PBX environment, the Softswitch 820 on an NT server over ATM can serve more than 10,000 phone users from a single NT server.

To reiterate the advantages of interfacing the ATM switch system via the ATM hub 420 to the hosting server 120, ATM network 800 can presently service approximately 200 phones for every T1 line. However, because ATM will increase in efficiency over time, this same system may handle several thousand phones with one T1 line in the future (without any hardware upgrades). This increase in efficiency will not require any increase in capacity of the line, and this is one of the advantages of this invention.

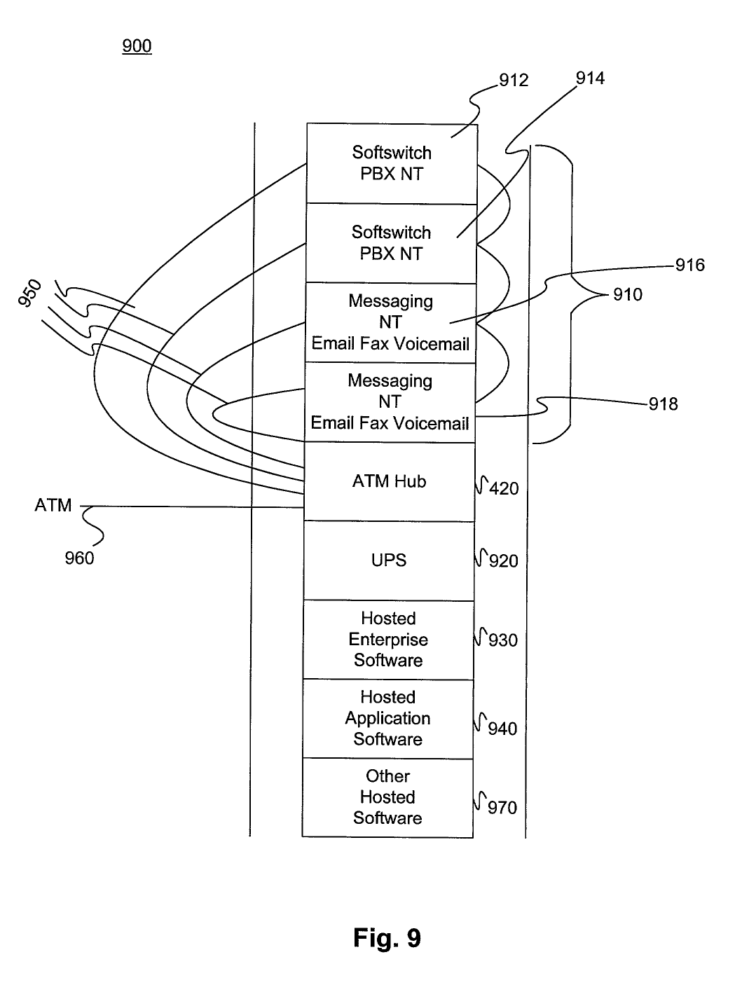

Notably, the Softswitch 820 interfaces the hosting server 120 with an ATM line (not shown in FIG. 8, but shown in the embodiment in FIG. 9, below). As a result, the hosting server 120 may connect users not only with PBX service but also with any other service that can be hosted on the hosting server 120 over an ATM connection. These additional services include voice mail, e-mail, and fax mail, for example. Note that the hosting server in this example may be provided by a business. Other embodiments may also be used.

FIG. 9 illustrates a block diagram illustrating a hosting server consistent with an embodiment of the present invention. Hosting server 900 is one embodiment of hosting server 120, as shown in FIG. 8. As shown in FIG. 9, the hosting server 900 may include multiple NT servers 910, an ATM Hub 420, an uninterruptible power supply (UPS) 920, hosted enterprise software 930, and software applications 940. Hosting server 900 may also include other hosted software 970.

As shown in FIG. 9, by having multiple NT servers 910, the hosting server 900 may switch from one operating server to another operating server if one server goes down, thereby minimizing potential downtime. For example, multiple NT servers 910 include Softswitch PBX NT server 912, Softswitch PBX NT server 914, messaging NT email fax voicemail server 916, and messaging NT email fax voicemail server 918. If Softswitch PBX NT server 912 fails, then Softswitch PBX NT server 914 can automatically be used by hosting server 900. Similarly, if messaging NT email fax voicemail server 916 fails, then messaging NT email fax voicemail server 918 can automatically be used by hosting server 900. These operations are controlled by ATM hub 420, which is connected to these servers via connections 950. The potential failure of these servers can be detected by connections 950.

As also shown in FIG. 9, the multiple NT servers 910 may include Softswitch PBX software on the Softswitch PBX NT servers 912, 914 for serving thousands of phone users. The multiple NT servers 910 may additionally or alternatively include software for handling unified messaging, such as, for example, e-mail, voice mail, and facsimiles. This option is shown as messaging NT email fax voicemail 916, 918.

As still also shown in FIG. 9, hosting server 900 is connected to outside entities via ATM hub 420 over an ATM line 960.

As further shown in FIG. 9, hosting server 900 also includes UPS 920. UPS 920 provides protection from glitches in power or power outages.

Hosting server 900 may include hosted communication services, which includes PBX services. This is made possible by Softswitch PBX NT servers 912, 914. With this capability, changes to the PBX can be entered electronically by users. In this manner, a business may add an additional business location with a certain number of lines electronically, without hardware modification. The electronic entry of one or more new lines may also specify PBX special features for the lines. For example, each line may be added with call waiting and call forwarding. All of these changes can be implemented electronically at the hosting server 900. Significantly, manual adjustment of wires at the customer premise is not necessary. Further, it is not necessary to reconfigure the hardware of the hosting server 900 to implement the changes. Finally, it is also not necessary to reconfigure the hardware at the telephone company (because the telephone company is not involved). As a result, changes to the PBX may be performed quickly and efficiently with these hosted communication services at hosting server 900.

As still further shown in FIG. 9, hosting server 900 may also include hosted enterprise software 930 and hosted application software 940. Hosting server 900 may include either or both of these software capabilities. Hosting server 900 may also include other hosted software 970. Hosting server 900 may include a variety of hosted services. The hosted application services may include hosted enterprise software 930, such as software enterprise applications by companies, such as, for example, Siebel Systems, Microsoft, and PeopleSoft. The hosted application services may also include hosted application software 940. The hosted application software 940 may be related to the core business of a business, or other software applications may also be provided. For example, the application software may include word processing software, sales force automation (SFA) software, contact management software, customer relationship software, etc. By providing such software, a customer or business may avoid the expense of purchasing, installing, and maintaining the software that is made available through these hosted services.

As with the hosted communication service, a business may enter changes to the hosted application software electronically. In this manner, a business may change the types of hosted application software it receives at a particular location electronically. In addition, the business may request hosted application software at a new location. The hosting server 900 may implement the request electronically, allowing for quick and efficient changes to the hosted application software.

C. Conclusion

Systems consistent with the present invention overcome the shortcomings of the conventional apparatus and methods for providing hosted services. By providing for hosted services using an asynchronous transfer mode connection, as described herein, the apparatus and methods of the invention as disclosed herein provided for improved processing of communications and applications, which overcome the shortcomings of the conventional apparatus and methods. Further, still other advantages are also possible using the described systems.

As described above, therefore, it will be apparent to those skilled in the art that various modifications and variations can be made in the apparatus and methods of the present invention without departing from the spirit and scope of the invention. Thus, it is intended that the present invention cover the modifications and variations of this invention, provided they come within the scope of the appended claims and their equivalents. In this context, equivalents mean each and every implementation for carrying out the functions recited in the claims, even if those particular functions are not explicitly described therein.

What is claimed is:

1. A method for providing a hosted service to a customer using asynchronous transfer mode (ATM), comprising the steps of:
hosting a communication service on a hosting server;
providing access to the hosting server via an ATM connection; and
allowing the customer to access the communication service at the hosting server via the ATM connection.

2. The method of claim 1, wherein the communication service includes private branch exchange (PBX) software.

3. The method of claim 2, wherein the PBX software allows the customer to modify the communication service electronically.

4. The method of claim 1, wherein the ATM connection connects to a frame relay, a world wide web, a public switch telephone network, or a global ATM system.

5. The method of claim 1, wherein the communication service processes voice information, data information, or single network message protocol information.

6. The method of claim 5, wherein the voice information includes information regarding local telephone service, long distance telephone service, and public branch exchange features.

7. The method of claim 5, wherein the data information includes information regarding a local data network, a wide area network, a virtual private network, unified messaging, or the Internet.

8. The method of claim 1, wherein an operating system of the hosting server includes Microsoft NT, UNIX, or LINUX.

9. The method of claim 1, wherein the hosting step further includes an application service.

10. The method of claim 9, wherein the hosted application service includes enterprise software or application software.

11. The method of claim 1, wherein
the customer includes a first user located at a first geographical location with a first user ATM hub and a second user located at a second geographical location with a second user ATM hub,
the ATM connection includes a first ATM switch system associated with the first user via the first user ATM hub and a second ATM switch system associated with the second user via the second user ATM hub, and
the first user connects to the second user via an ATM network that connects the first ATM switch system to the second ATM switch system.

12. A system for providing a hosted service to a customer using asynchronous transfer mode (ATM), comprising:
a hosting server for hosting a communication service;
an ATM connection for providing access to the hosting server; and
an access component for allowing the customer to access the communication service at the hosting server via the ATM connection.

13. The system of claim 12, wherein the communication service includes private branch exchange (PBX) software.

14. The system of claim 13, wherein the PBX software allows the customer to modify the communication service electronically.

15. The system of claim 12, wherein the ATM connection connects to a frame relay, a world wide web, a public switch telephone network, or a global ATM system.

16. The system of claim 12, wherein the communication service processes voice information, data information, or single network message protocol information.

17. The system of claim 16, wherein the voice information includes information regarding local telephone service, long distance telephone service, and public branch exchange features.

18. The system of claim 16, wherein the data information includes information regarding a local data network, a wide area network, a virtual private network, unified messaging, or the Internet.

19. The system of claim 12, wherein an operating system of the hosting server includes Microsoft NT, UNIX, or LINUX.

20. The system of claim 12, wherein the hosting server further hosts an application service.

21. The system of claim 20, wherein the hosted application service includes enterprise software or application software.

22. The system of claim 12, wherein
the customer includes a first user located at a first geographical location with a first user ATM hub and a second user located at a second geographical location with a second user ATM hub,
the ATM connection includes a first ATM switch system associated with the first user via the first user ATM hub and a second ATM switch system associated with the second user via the second user ATM hub, and
the first user connects to the second user via an ATM network that connects the first ATM switch system to the second ATM switch system.

23. A computer program product for providing a hosted service to a customer using asynchronous transfer mode (ATM), the computer program product comprising the following computer-readable program code for effecting actions in a computing platform:
program code for hosting a communication service on a hosting server;
program code for providing access to the hosting server via an ATM connection; and
program code for allowing the customer to access the communication service at the hosting server via the ATM connection.

24. A system for providing a hosted service to a customer using asynchronous transfer mode (ATM), comprising:
means for hosting a communication service on a hosting server;
means for providing access to the hosting server via an ATM connection; and
means for allowing the customer to access the communication service at the hosting server via the ATM connection.

25. A method for providing a hosted service to a customer using asynchronous transfer mode (ATM), comprising the steps of:
hosting a communication service on a hosting server with an ATM hub;
providing access to the hosting server via the ATM hub and an ATM switch system; and
allowing the customer to access the communication service at the hosting server via the ATM switch system.

26. The method of claim 25, wherein the customer obtains access to the ATM switch system via a customer ATM hub.

27. The method of claim 25, wherein the communication service includes private branch exchange (PBX) software.

28. The method of claim 27, wherein the PBX software allows the customer to modify the communication service electronically.

29. The method of claim 25, wherein
the customer includes a first user located at a first geographical location with a first user ATM hub and a second user located at a second geographical location with a second user ATM hub,
the ATM switch system includes a first ATM switch system associated with the first user via the first user ATM hub and a second ATM switch system associated with the second user via the second user ATM hub, and
the first user connects to the second user via an ATM network that connects the first ATM switch system to the second ATM switch system.

30. The method of claim 25, wherein the ATM switch system connects to a frame relay, a world wide web, a public switch telephone network, or a global ATM system.

31. The method of claim 25, wherein the communication service includes voice information, data information, or single network message protocol information.

32. The method of claim 31, wherein the voice information includes information regarding local telephone service, long distance telephone service, and public branch exchange features.

33. The method of claim 31, wherein the data information includes information regarding a local data network, a wide area network, a virtual private network, unified messaging, or the Internet.

34. The method of claim 25, wherein an operating system of the hosting server includes Microsoft NT, UNIX, or LINUX.

35. The method of claim 25, wherein the hosting step further includes an application service.

36. The method of claim 35, wherein the application service includes enterprise software or application software.

37. A system for providing a hosted service to a customer using asynchronous transfer mode (ATM), comprising:
a hosting server for hosting a communication service with an ATM hub;
an ATM switch system for providing access to the hosting server via the ATM hub; and
an access component for allowing the customer to access the communication service at the hosting server via the ATM switch system.

38. The system of claim 37, wherein the customer obtains access to the ATM switch system via a customer ATM hub.

39. The system of claim 37, wherein the communication service includes private branch exchange (PBX) software.

40. The system of claim 39, wherein the PBX software allows the customer to modify the communication service electronically.

41. The system of claim 37, wherein
the customer includes a first user located at a first geographical location with a first user ATM hub and a second user located at a second geographical location with a second user ATM hub,
the ATM switch system includes a first ATM switch system associated with the first user via the first user ATM hub and a second ATM switch system associated with the second user via the second user ATM hub, and
the first user connects to the second user via an ATM network that connects the first ATM switch system to the second ATM switch system.

42. The system of claim 37, wherein the ATM switch system connects to a frame relay, a world wide web, a public switch telephone network, or a global ATM system.

43. The system of claim 37, wherein the communication service includes voice information, data information, or single network message protocol information.

44. The system of claim 43, wherein the voice information includes information regarding local telephone service, long distance telephone service, and public branch exchange features.

45. The system of claim 43, wherein the data information includes information regarding a local data network, a wide area network, a virtual private network, unified messaging, or the Internet.

46. The system of claim 37, wherein an operating system of the hosting server includes Microsoft NT, UNIX, or LINUX.

47. The system of claim 37, wherein the hosting server further hosts an application service.

48. The method of claim 47, wherein the hosted application service includes enterprise software or application software.

49. A computer program product for providing a hosted service to a customer using asynchronous transfer mode (ATM), the computer program product comprising the following computer-readable program code for effecting actions in a computing platform:
program code for hosting a communication service on a hosting server with an ATM hub;
program code for providing access to the hosting server via the ATM hub and an ATM switch system; and
program code for allowing the customer to access the communication service at the hosting server via the ATM switch system.

50. A system for providing a hosted service to a customer using asynchronous transfer mode (ATM), comprising the steps of:
means for hosting a communication service on a hosting server with an ATM hub;
means for providing access to the hosting server via the ATM hub and an ATM switch system; and
means for allowing the customer to access the communication service at the hosting server via the ATM switch system.

51. A method for receiving a hosted service from a hosting server by a customer using asynchronous transfer mode (ATM), comprising the steps of:
accessing the hosting server by the customer via an ATM connection; and
receiving a communication service by the customer from the hosting server.

52. The method of claim 51, wherein the communication service includes private branch exchange (PBX) software.

53. The method of claim 52, wherein the PBX software allows the customer to modify the communication service electronically.

54. The method of claim 51, wherein the ATM connection connects to a frame relay, a world wide web, a public switch telephone network, or a global ATM system.

55. The method of claim 51, wherein the communication service includes voice information, data information, or single network message protocol information.

56. The method of claim 55, wherein the voice information includes information regarding local telephone service, long distance telephone service, and public branch exchange features.

57. The method of claim 55, wherein the data information includes information regarding a local data network, a wide area network, a virtual private network, unified messaging, or the Internet.

58. The method of claim 51, wherein an operating system of the hosting server includes Microsoft NT, UNIX, or LINUX.

59. The method of claim 51, wherein the receiving step further includes an application service from the hosting server.

60. The method of claim 59, wherein the application service includes enterprise software or application software.

61. The method of claim 51, wherein
the customer includes a first user located at a first geographical location with a first user ATM hub and a second user located at a second geographical location with a second user ATM hub,
the ATM connection includes a first ATM switch system associated with the first user via the first user ATM hub and a second ATM switch system associated with the second user via the second user ATM hub, and
the first user connects to the second user via an ATM network that connects the first ATM switch system to the second ATM switch system.

62. The method of claim 51, wherein the receiving step further includes:
accessing the communication service via a host ATM hub; and
obtaining the communication service from the host ATM hub via an ATM switch system.

63. A system for receiving a hosted service from a hosting server by a customer using asynchronous transfer mode (ATM), comprising:
an access component for accessing the hosting server by the customer via an ATM connection; and
a receive component for receiving a communication service from the hosting server.

64. The system of claim 63, wherein the communication service includes private branch exchange (PBX) software.

65. The system of claim 64, wherein the PBX software allows the customer to modify the communication service electronically.

66. The system of claim 63, wherein the ATM connection connects to a frame relay, a world wide web, a public switch telephone network, or a global ATM system.

67. The system of claim 63, wherein the communication service includes voice information, data information, or single network message protocol information.

68. The system of claim 67, wherein the voice information includes information regarding local telephone service, long distance telephone service, and public branch exchange features.

69. The system of claim 67, wherein the data information includes information regarding a local data network, a wide area network, a virtual private network, unified messaging, or the Internet.

70. The system of claim 63, wherein an operating system of the hosting server includes Microsoft NT, UNIX, or LINUX.

71. The system of 63, wherein the receive component further receives an application service.

72. The system of claim 71, wherein the application service includes enterprise software or application software.

73. The system of claim 63, wherein
the customer includes a first user located at a first geographical location with a first user ATM hub and a second user located at a second geographical location with a second user ATM hub,
the ATM connection includes a first ATM switch system associated with the first user via the first user ATM hub and a second ATM switch system associated with the second user via the second user ATM hub, and
the first user connects to the second user via an ATM network that connects the first ATM switch system to the second ATM switch system.

74. The system of claim 63, wherein the receive component comprises:
a host ATM hub for accessing the communication service; and
an ATM switch system for obtaining the communication service from the host ATM hub.

75. A computer program product for receiving a hosted service from a hosting server by a customer using asynchronous transfer mode (ATM), the computer program product comprising the following computer-readable program code for effecting actions in a computing platform:
program code for accessing the hosting server by the customer via an ATM connection; and
program code for receiving a communication service from the hosting server.

76. A system for receiving a hosted service from a hosting server by a customer using asynchronous transfer mode (ATM), comprising:
means for accessing the hosting server by the customer via an ATM connection; and
means for receiving a communication service from the hosting server.

77. A method for receiving a hosted service from a hosting server by a customer, comprising the steps of:
receiving a communication service by the customer, provided by the hosting server using asynchronous transfer mode (ATM), wherein the customer may request a change to the communication service via electronic implementation at the hosting server; and
receiving an application service, provided by the hosting server using asynchronous transfer mode (ATM), wherein the customer may request a change to the application service via electronic implementation at the hosting server.

78. The method of claim 77, wherein the ATM occurs by an ATM switch system.

79. The method of claim 78, wherein the ATM switch system connects to a frame relay, a world wide web, a public switch telephone network, or a global ATM system.

80. The method of claim 77, wherein the application service includes enterprise software or application software.

81. The method of claim 77, wherein the communication service includes voice information, data information, or single network message protocol information.

82. The method of claim 81, wherein the voice information includes information regarding local telephone service, long distance telephone service, and public branch exchange features.

83. The method of claim 81, wherein the data information includes information regarding a local data network, a wide area network, a virtual private network, unified messaging, or the Internet.

84. The method of claim 77, wherein
the customer includes a first user located at a first geographical location with a first user ATM hub and a second user located at a second geographical location with a second user ATM hub,
the ATM switch system includes a first ATM switch system associated with the first user via the first user ATM hub and a second ATM switch system associated with the second user via the second user ATM hub, and
the first user connects to the second user via an ATM network that connects the first ATM switch system to the second ATM switch system.

85. A system for receiving a hosted service from a hosting server by a customer, comprising:
a communication service receive component for receiving a communication service by the customer, provided by the hosting server using an asynchronous transfer mode (ATM), wherein the customer may request a change to the communication service via electronic implementation at the hosting server; and
an application service receive component for receiving an application service by the customer, provided by the hosting server using an asynchronous transfer mode (ATM), wherein the customer may request a change to the application service via electronic implementation at the hosting server.

86. The system of claim 85, wherein the ATM occurs by an ATM switch system.

87. The system of claim 85, wherein the ATM switch system connects to a frame relay, a world wide web, a public switch telephone network, or a global ATM system.

88. The system of claim 85, wherein the application service includes enterprise software or application software.

89. The system of claim 85, wherein the communication service includes voice information, data information, or single network message protocol information.

90. The system of claim 89, wherein the voice information includes information regarding local telephone service, long distance telephone service, and public branch exchange features.

91. The system of claim 89, wherein the data information includes information regarding a local data network, a wide area network, a virtual private network, unified messaging, or the Internet.

92. The system of claim 86, wherein
the customer includes a first user located at a first geographical location with a first user ATM hub and a second user located at a second geographical location with a second user ATM hub,
the ATM switch system includes a first ATM switch system associated with the first user via the first user ATM hub and a second ATM switch system associated with the second user via the second user ATM hub, and
the first user connects to the second user via an ATM network that connects the first ATM switch system to the second ATM switch system.

93. A computer program product for receiving a hosted service from a hosting server by a customer, the computer program product comprising the following computer-readable program code for effecting actions in a computing platform:
program code for receiving a communication service by the customer, provided by the hosting server using asynchronous transfer mode (ATM), wherein the customer may request a change to the communication service via electronic implementation at the hosting server; and
program code for receiving an application service by the customer, provided by the hosting server using asynchronous transfer mode (ATM), wherein the customer may request a change to the application service via electronic implementation at the hosting server.

94. A system for receiving a hosted service from a hosting server by a customer, comprising:
means for receiving a communication service by the customer, provided by the hosting server using asynchronous transfer mode (ATM), wherein the customer may request a change to the communication service via electronic implementation at the hosting server; and
means for receiving an application service by the customer, provided by the hosting server using asynchronous transfer mode (ATM), wherein the customer may request a change to the application service via electronic implementation at the hosting server.
